(19) United States
(12) Patent Application Publication
(10) Pub. No.: US 2025/0277631 A1
(43) Pub. Date: Sep. 4, 2025

(54) SEALING ARRANGEMENTS FOR ROTARY ADSORPTION MACHINES

(71) Applicant: Howden Group Limited, Scotland (GB)

(72) Inventors: Brijeshkumar Patel, Glasgow (GB); Ryan Mochar, Cumbernauld (GB); Gwyn Ashby, Kilmacolm (GB); Joanne Moore, Falkirk (GB); Dougal Hogg, Glasgow (GB)

(21) Appl. No.: 19/063,832

(22) Filed: Feb. 26, 2025

Related U.S. Application Data
(60) Provisional application No. 63/560,125, filed on Mar. 1, 2024.

(51) Int. Cl. F28D 19/04

(52) U.S. Cl. CPC F28D 19/047; F28F 2230/00

(57) ABSTRACT

A rotary machine includes a rotor that is configured to rotate, a housing that encloses the rotor, and an elastomeric member that is attached to the housing. The housing includes a plate extending along the rotor, and the elastomeric member extends from the plate to form a seal with the rotor.

### CROSS-REFERENCE TO RELATED APPLICATIONS

This application claims priority to and the benefit of U.S. Provisional Patent Application No. 63/560,125, filed Mar. 1, 2024, which is hereby incorporated by reference in its entirety for all purposes.

### FIELD OF INVENTION

The present invention relates to sealing arrangements between zones of rotary heat exchangers, rotary adsorption machines and the like.

### BACKGROUND

Rotary adsorption machines (RAMs), which are also known as thermal swing adsorption machines, pressure swing adsorption machines, regenerative rotary separators, and the like, are often deployed to recover specific gasses, elements, and/or particulates, such as carbon dioxide. More specifically, rotary adsorption machines are often deployed for point source carbon capture and/or for direct air carbon capture. In any case, RAMs typically include an adsorbent material, such as activated carbon, metal-organic frameworks (MOFs) or zeolite (e.g., hydrated aluminosilicates of alkaline and alkaline-earth metals), in a rotatable rotor.

Some RAMs include a cylindrical section that is configured to circumferentially surround the rotor and to define a plurality of zones through which the rotor can rotate. A plurality of ducts may define passageways into and out of the plurality of zones, and the cylindrical section may connect an inlet of each duct of the plurality of ducts to an outlet of each duct of the plurality of ducts. These zones can include an adsorption zone, a desorption zone, and a regeneration zone that typically operate at different temperatures and pressures. Two or more sector plate assemblies may define and/or separate adjacent zones. Meanwhile, in the rotor, radial plates extend between a central hub and an outer shell of the cylindrical section to at least partially define containers within which the adsorbent material is retained.

The process gas, such as a carbon dioxide (CO₂)-laden gas, enters the rotor, and the target gasses, elements, and/or particulates (e.g., CO₂) is/are adsorbed onto the adsorbent material. The rotor then rotates the adsorbed substance into a desorption zone to release the target substance from the adsorbent so that the target substance can be captured, processed, or used. The desorption is caused by a change in pressure and/or a change in temperature (e.g., by passing steam through the rotor or through electric heating elements). Since these different zones are capturing and releasing a target substance and operate at different pressures, it is quite important to provide proper seals between the zones to limit or eliminate fluid flow/leakage between them.

### SUMMARY

Disclosed are apparatuses for minimizing or eliminating leakage between adjacent zones of a rotary machine, such as a RAM. That is, while the present disclosure primarily describes seal applications for RAMs, the sealing arrangements disclosed herein are equally applicable to minimizing or eliminating leakage between adjacent zones of a rotary heat exchanger, such as a low temperature rotary heat exchanger (e.g. those operating at less than 200° C.) or a cold temperature rotary heat exchanger, and like machines.

According to some implementations, a rotary machine is provided. The rotary machine includes a rotor with a plurality of plates defining openings therebetween, and the rotor is configured to rotate to move the plurality of plates. The rotary machine also includes a housing enclosing the rotor, and an elastomeric member attached to a surface of the housing. The elastomeric member extends from the surface of the housing toward the rotor and is curved to form a convex shape with an apex configured to intermittently and sequentially engage with the plurality of plates to form a seal with the rotor during rotation of the rotor.

According to some implementations, a sealing arrangement for a rotary machine is provided. The sealing arrangement includes a housing segment extending along a rotor of the rotary machine. The rotor includes a plurality of radial plates, and the rotor is configured to rotate the plurality of radial plates. The sealing arrangement also includes an elastomeric member with side ends configured to attach to opposite walls of the housing segment to capture the housing segment between the side ends. The elastomeric member extends from the housing segment toward the rotor to intermittently and sequentially engage with the plurality of radial plates of the rotor as the rotor rotates the plurality of radial plates.

According to some implementations, a rotary machine is provided. The rotary machine includes a rotor with a plurality of radial plates. The rotor is configured to rotate to move the plurality of radial plates. The rotary machine also includes a housing enclosing the rotor and having a segment extending along the rotor, as well as an elastomeric member attached to the plate of the housing and extending from the segment to sealingly engage with the rotor and form a gap between the elastomeric member and the segment.

According to some implementations, a RAM is provided that comprises an adsorption zone, a desorption zone and a regeneration zone. Disposed between two adjacent zones is a sector plate having a first surface. The RAM includes a rotatable rotor having a plurality of spaced-apart radial plates that at least partially define containers within which an adsorbent material may be retained. Each of the plurality of radial plates has a second surface that is configured to intermittently face the first surface of the sector plate as the rotor rotates. A first elastomeric member is attached to the sector plate that extends over a portion or all of the first surface. In the context of the present disclosure, an elastomeric member is one that is able to bend or deform when a load is applied to it and is able to fully recover or substantially recover its original shape when the load is removed. In this context, the term “elastomeric” encompasses multiple options for material of construction.

The first elastomeric member has an inner surface and an outer surface opposite the inner surface with the inner surface facing towards the first surface of the sector plate. The first elastomeric member is constructed in a manner that results in a gap/cavity existing between the inner surface of the first elastomeric member and the first surface of the sector plate. The second surfaces of the plurality of radial plates are configured to intermittently and sequentially touch or press against the outer surface of the first elastomeric member to form a seal between the adsorption zone and desorption zone, or the adsorption zone and the regeneration zone, or the desorption zone and the regeneration zone, as the case may be. According to some implementations, the outer surface of the first elastomeric member is curved to form a convex shape with an apex pointing away from the first surface of the sector plate.

According to some implementations, the sector plate, first elastomeric member, and each of the plurality of radial plates are arranged such that the second surfaces of the plurality of radial plates sequentially touch or press against the outer surface of the first elastomeric member only in an area of the curved convex shape.

It is important to note that the radial plate may contact the elastomeric material directly. Alternatively, one or more elements/fixtures may be attached the top and bottom of the radial plates with the attachment itself being designated to contact the first elastomeric material. According to some implementations, the one or more elements/fixtures may be radial seals attached to the top and bottom of the radial plates that intermittently contact the first elastomeric material as the radial plates pass under or over the sector plates. A radial seal may comprise any structure that is capable of contacting the first elastomeric member of the sector plate to effectuate a seal between adjacent zones of the RAM. According to some implementations, the radial seal comprises another elastomeric member that is configured to engage with the first elastomeric member of the sector plate. The radial seal may be made of other materials, such as, for example, other plastic materials and/or metal materials.

According to some implementations, the convex shape includes a curved area having a constant radius of curvature and the second surface of the radial plates touches or presses against the outer surface of the first elastomeric member only in an area of constant radius of curvature. This latter feature makes for a smoother flexing of the first elastomeric member when the second surfaces of the radial plates pass along the outer surface of the first elastomeric member. This advantageously contributes to extending the useful life of the first elastomeric member.

According to some implementations, a second elastomeric member is located in the gap/cavity between the inner surface of the first elastomeric member and the first surface of the sector plate. This feature provides redundancy in that upon an inadvertent failing of the first elastomeric member (e.g. upon the first elastomeric member being broken/severed), the second surfaces of the radial plates may thereafter act against at least a portion of the second elastomeric member to maintain a seal, or to otherwise minimize fluid flow leakage across the sector plate. In addition, the second elastomeric member functions to support the first elastomeric member and can be used to regulate/determine the amount by which the first elastomeric member flexes towards the sector plate when the second surfaces of the radial plates press against the outer surface of the first elastomeric member. According to some implementations the second elastomeric member is softer than the first elastomeric member (i.e. has a lower Young's modulus than the first elastomeric member).

According to some implementations, the second elastomeric member is a unitary structure that is made from a single piece of material. However, according to other implementations the sector plate has a width, and disposed in the gap/cavity between the inner surface of the first elastomeric member and the first surface of sector plate are a plurality of elongate elastomeric members that are arranged side-by-side along at least a portion of the width of the first surface. According to some implementations, one or more or all of the elongate elastomeric members is in the form of a solid cylinder or a hollow cylinder. The diameter of the cylinders may be the same or may vary. According to some implementations, one or more or all of the elongate elastomeric members is/are made of a material that is softer than the material from which the first elastomeric member is made (i.e. has a lower Young's modulus than the material from which the first elastomeric member is made).

According to some implementations, the second surface of the plurality of radial plates is curved for the purpose of reducing the risk of the first elastomeric member being punctured by the radial plates. According to some implementations the second surface of the plurality of radial plates is coated with a lubricious material that reduces friction forces between the radial plates and the outer surface of the first elastomeric member. This assists in providing a smoother flexion and shape recovery of the first elastomeric member as the second surfaces of the radial plates sequentially pass along the outer surface of the first elastomeric member. As a result, the useful life of the first elastomeric member may be extended.

These and other advantages and features will become evident in view of the drawings and detailed description.

### BRIEF DESCRIPTION OF THE DRAWINGS

To complete the description and in order to provide for a better understanding of the present invention, a set of drawings is provided. The drawings form an integral part of the description and illustrate an implementation of the present invention, which should not be interpreted as restricting the scope of the invention, but just as an example of how the invention can be carried out. The drawings comprise the following figures:

FIG. 1 is a schematic view of a combined cycle power plant with a rotary adsorption machine (RAM) formed in accordance with an example implementation.

FIG. 2 is a top, front perspective view of a RAM formed in accordance with an example implementation.

FIG. 3 is a partially cut-away perspective view of a portion of the RAM of FIG. 2.

FIG. 4A is a cross-sectional view of a sector plate assembly of the RAM of FIG. 2 according to one implementation.

FIG. 4B is a cross-sectional view of an elastomeric member of the sector plate assembly shown in FIG. 4A.

FIG. 4C is a cross-sectional view of a sealing arrangement that includes a radial plate touching or pressing against an outer surface of an elastomeric member of the sector plate assembly of FIG. 4A to effectuate a seal between a sector plate and the radial plate.

FIG. 5A is a cross-sectional view of a sector plate assembly according to another implementation.

FIG. 5B is a cross-sectional view of a sealing arrangement that includes the sector plate assembly of FIG. 5A with an elastomeric member disposed inside a gap/cavity that exists between an inner surface of the elastomeric member and a surface of a sector plate.

FIG. 6 is a cross-sectional view of a sector plate assembly according to another implementation.

FIG. 7A is a cross-sectional view of another sealing arrangement that includes a plurality of elongate elastomeric members disposed inside a gap/cavity that exists between an inner surface of an elastomeric member and a surface of a sector plate.

FIG. 7B is a perspective view of an elongate elastomeric member of the sealing arrangement of FIG. 7A according to one implementation.

FIG. 7C is a perspective view of an elongate elastomeric member of the sealing arrangement of FIG. 7A according to another implementation.

FIG. 8A illustrates a radial plate with an end surface that is configured to touch or press against an outer surface of an elastomeric member, the end surface being rounded or otherwise curved.

FIG. 8B shows the radial plate of FIG. 8A with the end surface comprising a lubricious coating.

FIG. 9A illustrates a radial plate with an end surface that is configured to touch or press against an outer surface of an elastomeric member, the end surface being chamfered.

FIG. 9B shows the radial plate of FIG. 9A with the end surface comprising a lubricious coating.

FIG. 10A illustrates a radial plate with an end surface that is configured to touch or press against an outer surface of an elastomeric member, the end surface being sloped on the leading side of the radial plate.

FIG. 10B shows the radial plate of FIG. 10A with the end surface comprising a lubricious coating.

FIG. 11 is a detailed view of a portion of the RAM of FIG. 2.

FIG. 12 is a top view of a sealing arrangement that includes a radial plate touching or pressing against an outer surface of an elastomeric member of an axial plate assembly to effectuate a seal between an axial plate and the radial plate of the RAM of FIG. 2 according to one implementation.

### DETAILED DESCRIPTION

Generally, this application is directed to a rotary adsorption machine (RAM). Disclosed herein are sealing arrangements to reduce or eliminate the leakage of fluids (gases and/or liquids) between zones of the RAM for the purpose of increasing its effectiveness. Although the present disclosure is directed to RAMs, the sealing arrangements disclosed herein are equally applicable to minimizing or eliminating leakage between adjacent zones of a rotary heat exchanger and like machines, such as a low temperature mine air heater.

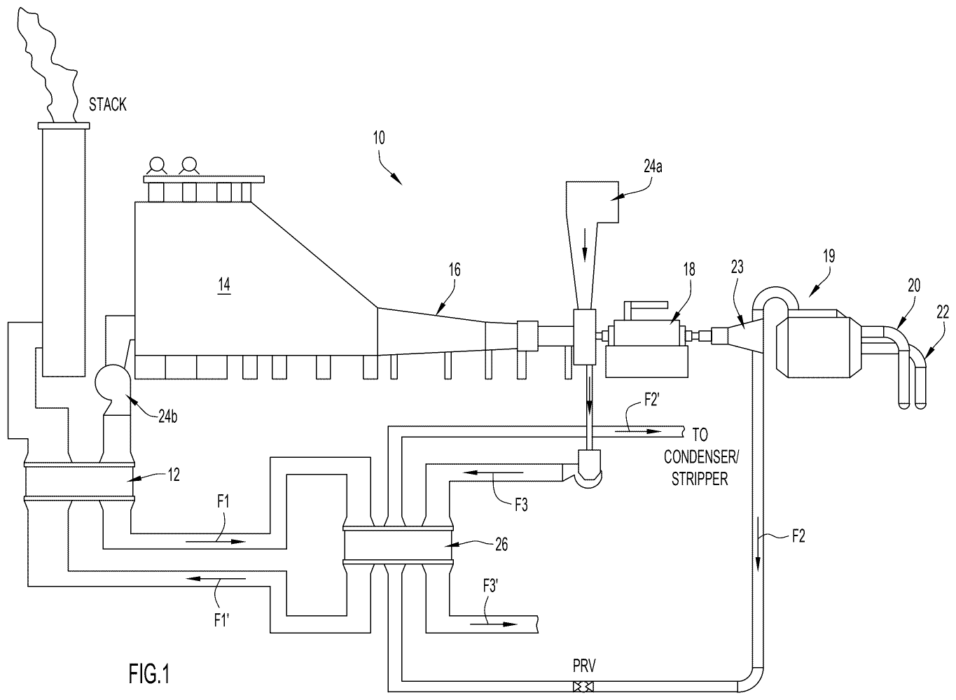

An example power plant 10 of a type that may incorporate a RAM 26 formed in accordance with the present application is illustrated in FIG. 1. However, to be clear, the power plant 10 of FIG. 1 is merely an example and, in other implementations, RAM 26 may be positioned in any desirable location, e.g., for carbon capture. For example, power plant 10 generally depicts a combined cycle gas turbine (CCGT) power plant, but the RAM 26 could also be positioned/included in a conventional coal powered power plant or any other flue system (e.g., for point source capture). In fact, it is envisioned that the RAM 26 presented herein may be configured to capture carbon dioxide from ambient air. That is, the RAM 26 presented herein may be positioned in locations in which CO₂-laden gas entering the RAM 26 is ambient air (as opposed to a process effluent).

That said, in FIG. 1, the power plant 10 includes a gas turbine 16, a Heat Recovery Steam Generator (HRSG) 14, and a generator 18 coupled with a steam turbine 23. Turbines 16 and 23 combine to drive the generator 18 to produce electricity. The steam turbine 23 is connected to a condenser 19 with an intake 20 and exhaust 22. The power plant 10 also includes fans 24a and 24b, which may be used to move air through this system. Meanwhile, a heat exchanger 12 may be positioned adjacent the exhaust of the HRSG 14. Although not shown, a power plant utilizing the RAM 26 might also include another heat exchanger to heat the air entering a boiler. For example, such a heat exchanger might heat air entering a boiler with heat from combustion gases expelled from the boiler (while also cooling the gas expelled from the boiler).

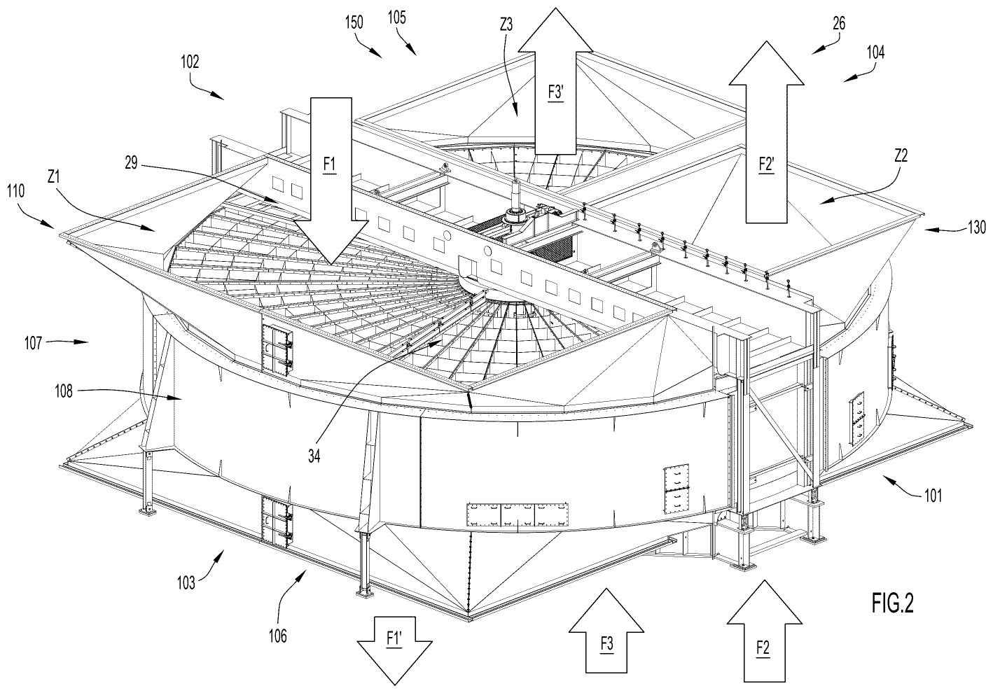

As shown in FIG. 1 and in combination with FIG. 2, which illustrates the RAM 26 of FIG. 1 in further detail, the cooled exhaust gas enters the RAM 26 as a first flow F1 and enters the RAM 26 via a first duct 110. However, to reiterate, exhaust gas is merely one example of gas that may enter the RAM 26 as first flow F1. As other examples, the first flow F1 may be a flow of ambient air and/atmosphere, or a combination of ambient air/atmosphere and an exhaust gas. In any case, when the first flow F1 encounters a rotor 34 included in the RAM 26, adsorptive elements in the rotor 34 can adsorb a specific portion of the first flow F1 (e.g., carbon dioxide). Then, the adsorptive elements in the rotor 34 can carry the adsorbed portion of the first flow F1 through a partial rotation. Meanwhile, a portion of the first flow F1 that is not captured by the adsorptive elements may exit the RAM 26 as process flow F1′, e.g., to (or back to) atmosphere, e.g., by way of heat exchanger 12 where it can be used to cool exhaust gas. Additionally or alternatively, the process flow F1′ could be fed to a conduit that directs the process flow F1′ to a downstream processing operation that requires clean gas/air. The area of the rotor 34 aligned with the first flow F1 may generally be referred to herein as a first zone Z1 (i.e., an adsorptive zone Z1) of the RAM 26.

As the rotor 34 rotates, it moves the adsorbed portion of the first flow F1 (e.g., carbon dioxide) out of the adsorptive zone Z1 (e.g., by rotating the adsorptive elements that have adsorbed the portion of the first flow F1) and into a second zone Z2 (i.e., a desorption zone Z2) of the RAM 26. In the desorption zone Z2, a second flow F2 is directed into the RAM 26 to cause the adsorptive elements of rotor 34 carrying the adsorbed portion of the first flow F1 to desorb the adsorbed portion of the first flow F1. For example, steam may be directed into the RAM 26 as the second flow F2 to create a temperature change that releases carbon dioxide from adsorptive elements for carbon capture. To illustrate this example, the steam of the second flow F2 emanates from steam turbine operations (e.g., from condenser 19) in FIG. 1. In any case, the adsorbed portion of the first flow F1 is released into the second flow F2 to generate a flow F2′ exiting RAM 26. By way of example, the flow F2′ may carry carbon dioxide and may be directed to a storage tank, condenser, and/or stripper, e.g., to prevent the carbon dioxide from entering or re-entering the atmosphere (e.g., to remove carbon dioxide from the atmosphere).

After adsorptive elements desorb the adsorbed portion of the first flow F1 (e.g., carbon dioxide), the adsorptive elements may move into a third zone Z3 (i.e., a regeneration zone Z3). In the third zone Z3, conditioning air (e.g., driven by fan 24a) may flow through the RAM 26 to “regenerate” the adsorptive elements, entering as flow F3 and exiting as flow F3′ (which, may, in some instances, combine with the process flow F1′ on exiting the RAM 26, as shown in FIG. 1). This conditioning air prepares the adsorptive elements to re-enter the adsorption zone Z1 (e.g., by cooling the adsorptive elements) so that the adsorptive elements can continue cycling through the three zones of the RAM 26. That is, continued rotation of a particular adsorptive element of rotor 34 through a full 360° rotation within the RAM 26 will cause the particular adsorptive element to adsorb a specific portion of the first flow F1, desorb the flow component, and regenerate. Thus, a cylindrical rotor 34 full of adsorptive elements will continuously capture a component/portion of a first flow of gas F1 entering the RAM 26.

However, to be clear, the RAM 26 illustrated in the figures of this application is merely an example and other implementations may include any number of variations. For example, a RAM 26 formed in accordance with the present application may include any number of zones, e.g., to incorporate isolation zones, multiple stages or regeneration, desorption, and/or adsorption, or for any other reason. Additionally or alternatively, the various flows entering and exiting the RAM 26 may emanate from any desirable source or flow to any desirable location, including a source of that flow or another flow (e.g., to recycle flows of fluid). As yet another example, the composition of the various flows can be varied, such as by using a fluid flow other than steam for desorption.

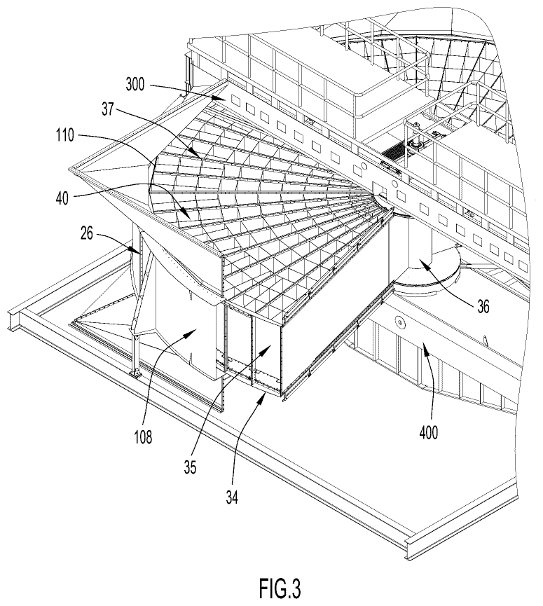

FIG. 3 illustrates the RAM 26 of FIG. 2 in greater detail by providing a cut-away view of a portion of the RAM 26. FIGS. 2 and 3 are discussed together to describe the RAM 26. At a high-level, the RAM 26 includes a rotor 34 that is rotatable within a housing 107. The housing 107 is specifically designed to enclose and seal against portions of the rotor 34 to help dictate how and where fluid (e.g., gas) will enter, exit, or move with the rotor 34. As mentioned, the RAM 26 presented herein, including the housing 107 and rotor 34, may be particularly suitable for large scale (e.g., industrial) operations. Thus, in at least some instances, the rotor 34 may have a diameter equal to or greater than 20 meters, such as 24 meters, and the housing 107 may be sized accordingly.

As can be seen in FIG. 3, the rotor 34 includes a central hub 36 and an outer shell 35. Radial plates 37 extend between the central hub 36 and the outer shell 35 and are offset from one another to at least partially define containers or openings 40 therebetween. The containers 40 are configured to receive and retain adsorbent material. In at least some implementations, the rotor 34 also includes circumferential plates to subdivide the containers 40. Either way, adsorbent material may be stored and/or installed within the containers 40. For example, adsorbent material may be “dropped down” into the containers 40 to fill the rotor 34 with adsorbent material. In at least some instances, the adsorbent may be formed from any adsorbent now known or developed hereafter that is suitable for adsorbing carbon dioxide, such as activated carbon, MOFs, zeolite(s), or combinations thereof.

As mentioned, the rotor 34 is configured to continuously rotate around the central hub 36 to move radially aligned containers 40 through a cycle of zones (e.g., through zones Z1, Z2, and Z3). During this rotation, the housing 107 is generally designed to circumferentially retain gas in the rotor 34 and to create pathways along which fluid can axially enter or exit the rotor 34. The circumferential retention can be achieved by closely positioning a cylindrical section 108 of the housing 107 against the outer shell 35 of the rotor 34. Additionally, sector plates/segments located between the zones of the RAM are equipped with features that facilitate producing a seal between the zones for the purpose of minimizing or eliminating fluid flow between the zones. FIG. 2 shows an example sector plate/segment 29 positioned between the adsorption zone (Z1) and the regeneration zone (Z3) and above the radial plates 37. In the depicted implementation, a first sector plate 29 separates the adsorption zone Z1 (generally aligned with first duct 110) from at least the regeneration zone Z3.

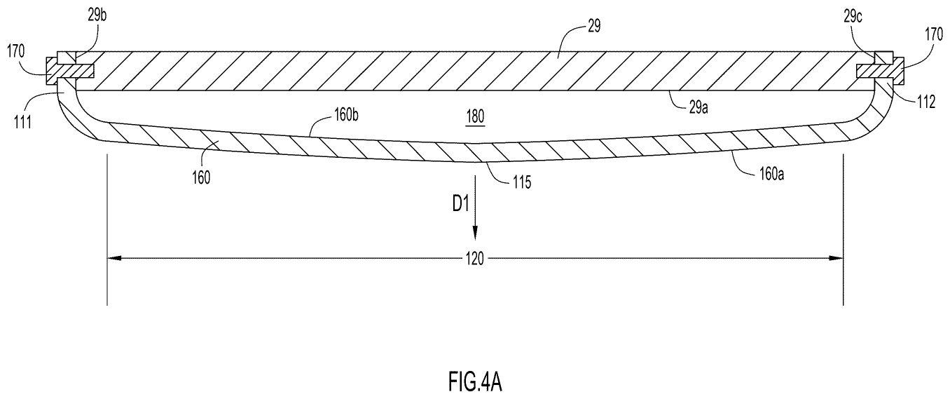

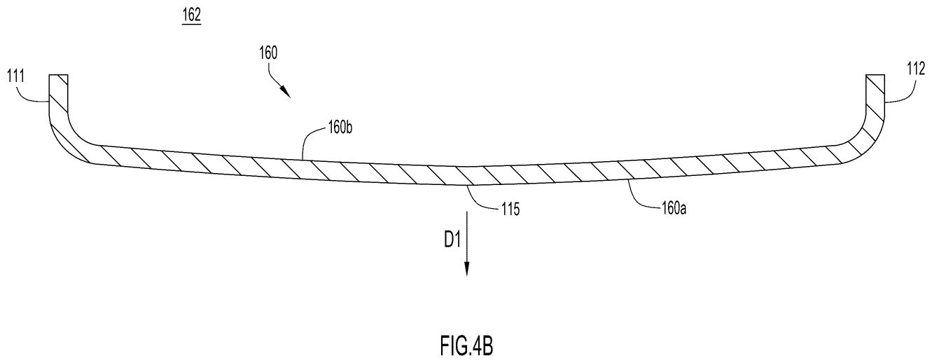

The examples disclosed below are directed to sealing arrangements between the first sector plate 29 and radial plates 37. Moreover, the examples are directed to sealing arrangements between an end surface 37a (e.g., an outer surface, a top surface, see, e.g., FIG. 4C) of the radial plates 37 and a first surface 29a (e.g., an inner surface, a bottom surface, a lower surface, see, e.g., FIG. 4c) of the first sector plate 29. A second sector plate (not shown in the figures), similar to and horizontally aligned with the first sector plate 29 is typically disposed below the radial plates 37. The sealing arrangements disclosed herein are equally applicable to producing a seal between a bottom end of the radial plates 37 with a top surface of the second sector plate. Similarly, the sealing arrangements disclosed herein may be equally applicable to longitudinally extending surfaces extending between the bottom and top sector plates. (e.g., vertically extending portions of a sector assembly). With reference to FIGS. 2 and 3, the aforementioned first and second sector plates may be respectively attached or coupled to top and bottom frame assemblies 300 and 400 of RAM 26. Although not shown in FIG. 2, similar sets of sector plates may be disposed between the adsorption zone (Z1) and desorption zone (Z2) and also between the desorption zone (Z2) and the regeneration zone (Z3).

With continued reference to FIGS. 2 and 3, overall, the housing 107 extends from a front 101 to a back 102, from a first side 103 to a second side 104, and from a bottom 106 to a top 105. In the depicted implementation, different streams of fluid enter or exit the RAM 26 in a generally vertical or longitudinal manner (i.e., from the bottom 106 to the top 105, or vice versa). Thus, the housing 107: (a) includes a cylindrical section 108 that circumferentially surrounds the rotor 34; and (b) defines a plurality of ducts at the top 105 and bottom 106 of the RAM 26. Specifically, in the depicted implementation, the RAM 26 includes three ducts that are generally aligned with zones Z1, Z2, and Z3: (1) a first duct 110 generally aligned with adsorption zone Z1; (2) a second duct 130 generally aligned with desorption zone Z2; and (3) a third duct 150 generally aligned with regeneration zone Z3. However, other implementations may include any number of ducts and do not necessarily need to include the same number of ducts and zones.

In the depicted implementation, the first duct 110 extends from an inlet disposed adjacent the top 105 of the housing 107 to an outlet disposed adjacent the bottom 106 of the housing 107. Meanwhile, the second duct 130 and third duct 150 extend from inlets that are positioned adjacent to the bottom 106 of the housing 107 to outlets that are respectively positioned adjacent to the top 105 of the housing 107. Thus, the first flow F1 entering the first duct 110 generally flows in a first longitudinal direction (e.g., downwards) while flows F2 and F3 entering ducts 130 and 150 generally flow in an opposite longitudinal direction (e.g., upwards). As specific examples, the first flow F1 may comprise ambient air and/or a process effluent flowing downwards into the rotor 34 via the inlet of the first duct 110 while the second flow F2 comprises steam flowing upwards into the rotor 34 via the inlet of second duct 130 and the third flow F3 comprises conditioning air flowing upwards into rotor 34 via the inlet of third duct 150.

In the examples that follow, reference is made to sector plates 29 situated between the adsorption zone (Z1) and the regeneration zone (Z3) of a RAM. It is appreciated that the invention is equally applicable to other locations of the RAM, including sector plates located between other zones of the RAM 26 and/or locations that prevent leakage between adjacent zones and/or circumferential leakage around a rotor and/or matrix.

FIG. 4A is a cross-sectional view of a sector plate assembly 162 with a sector plate 29 attached to a first elastomeric member 160 that extends across a first surface 29a of the sector plate. In the context of the present disclosure, an elastomeric member is able to bend or deform when a load is applied to it, and the elastomeric member is able to fully recover or substantially recover its original shape when the load is removed. In this context, the term “elastomeric” encompasses multiple options for material of construction.

The first elastomeric member 160 has a first side end 111 and an opposite second side end 112 that are respectively attached or otherwise coupled to first and second side walls 29b and 29c of the sector plate 29 to capture the sector plate 29 between the side ends 111, 112. In fact, while not shown, in some instances, the first elastomeric member 160 may fully capture the sector plate 29, e.g., by wrapping around lateral sides of the sector plate 29, with the lateral sides bounding a direction that extends perpendicularly to a direction spanning side ends 111 and 112. In other instances, however, the lateral sides of the sector 29 need not be captured and/or need not be fully covered, if desired. In any case, in the implementation shown in FIG. 4A, attachment of the first elastomeric member 160 to the sector plate 29 is achieved through the use of screws or bolts 170. Other attachment means, such as an adhesive, may also be used. Similar attachment techniques could also be used at lateral sides of the sector plate 29, if desired. In the example of FIG. 4A the first elastomeric member 160 extends over all of the first surface 29a of the sector plate 29. However, according to other implementations, the first elastomeric member 160 may extend over only a portion of the first surface 29a, with said portion preferably being a central portion of the first surface 29a.

The first elastomeric member 160 has an outer surface 160a and an inner surface 160b opposite the outer surface 160a, with the inner surface 160b facing towards the first surface 29a of the sector plate 29. The first elastomeric member 160 is constructed in a manner that results in a gap/cavity 180 existing between the inner surface 160b of the first elastomeric member and the first surface 29a of the sector plate 29. According to some implementations, the outer surface 160a of the first elastomeric member 160 is curved to form a convex shape with an apex 115 pointing in a direction (D1) away from the first surface 29a of the sector plate 29.

FIG. 4B is a cross-sectional view the of the first elastomeric member 160 shown in FIG. 4A. The first elastomeric member 160 has a U-shaped configuration in which the side ends 111, 112 extend away from the apex 115 (e.g., opposite the direction D1), thereby forming the gap 180 while the first elastomeric member 160 is attached to the sector plate 29. The side ends 111, 112 may have apertures to receive the screws 170 for attaching the first elastomeric member 160 to the sector plate 29.

FIG. 4C is a cross-sectional view of a sealing arrangement 100 according to one implementation in which the sector plate 29 of FIG. 4A is aligned with one of the plurality of radial plates 37 of a rotor (e.g., the rotor 34) of a RAM (e.g., the RAM 26). That is, an end surface 37a (also referred to herein as “second surface”) of the radial plate 37 is situated facing the first surface 29a of the sector plate 29. In the example of FIG. 4C, the radial plate 37 has first and second opposite sides 37b and 37c that respectively reside in zones Z1 and Z3 of the RAM. For discussion purposes only, zone Z1 will be assumed to operate at a higher pressure than zone Z3. As previously discussed, the radial plate 37 is one of a plurality of spaced-apart radial plates that rotates inside a housing of the RAM. Arrow “R” indicates the direction of rotation.

The sealing arrangement 100 comprises the first elastomeric member 160 attached to the sector plate 29 with the second surface 37a of the radial plate 37 touching or pressing against the outer surface 160a of the first elastomeric member 160 to effectuate a seal between the first elastomeric member 160 and the second surface 37a of radial plate 37. Thus, when the radial plate 37 is aligned with the first elastomeric member 160 and the sector plate 29 (e.g., when the radial plate 37 is positioned between the zones Z1 and Z3), the radial plate 37 seals against the first elastomeric member 160. In particular, the elastomeric material of the first elastomeric member 160 urges the first elastomeric member 160 away from the sector plate 29, thereby positioning the first elastomeric member 160 (e.g., the apex 115) to readily engage with the radial plate 37 moved into alignment with the sector plate 29.

However, contact between the radial plate 37 and the first elastomeric member 160 may impart a force onto the first elastomeric member 160 to cause the first elastomeric member 160 to flex toward the sector plate 29, thereby enabling the radial plate 37 to traverse the outer surface 160a and avoid inhibiting the rotation of the rotor. Rotation of the rotor of the RAM may move various radial plates 37 of the plurality of radial plates between the zones Z1 and Z3 and therefore into and out of alignment with the first elastomeric member 160. Consequently, the second surfaces 37a of the plurality of radial plates 37 are arranged to intermittently and sequentially touch or press against the outer surface 160a of the first elastomeric member 160. The first elastomeric member 160 repeatedly flexes away from the sector plate 29 to form a seal that prevents, or at least minimizes, fluid flow between zones Z1 and Z3, or between other sets of zones as discussed above and toward the sector plate 29 to facilitate rotation of the rotor.

According to some implementations, the sector plate 29, first elastomeric member 160, and each of the plurality of radial plates 37 are arranged such that the second surfaces 37a of the plurality of radial plates 37 intermittently and sequentially touch or press against the outer surface 160a of the first elastomeric member 160 only in an area of the curved convex shape (e.g., at the apex 115). According to some implementations, the convex shape includes a curved area 120 (see FIG. 4A) having a constant radius of curvature, and the second surfaces 37a of the radial plates 37 contact the outer surface 160a of the first elastomeric member 160 only in an area of constant radius of curvature. This latter feature makes for a smoother flexion and shape recovery of the first elastomeric member 160 as the second surfaces 37a of the radial plates 37 pass along the outer surface 160a. This advantageously lengthens the useful life of the first elastomeric member 160.

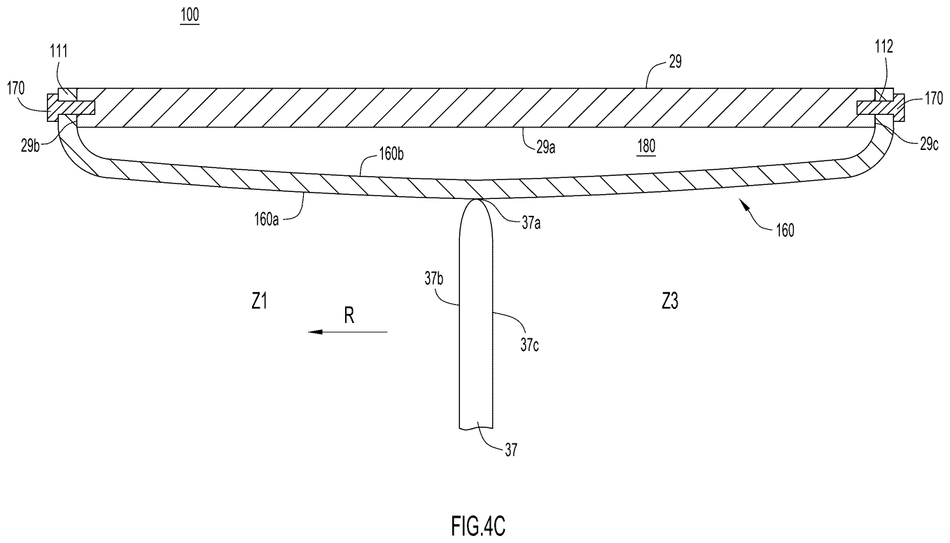

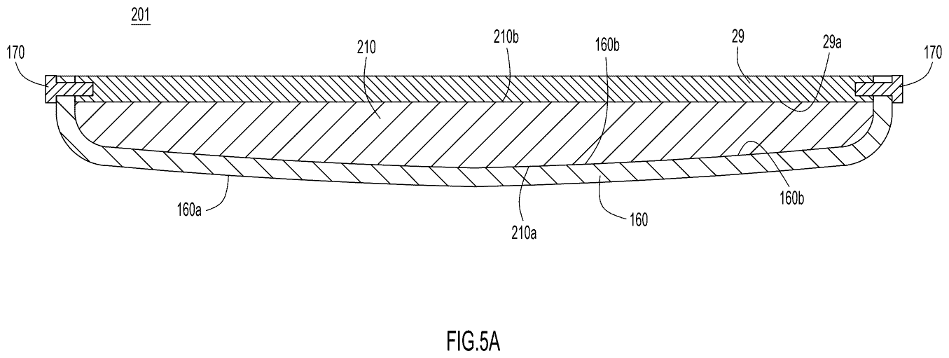

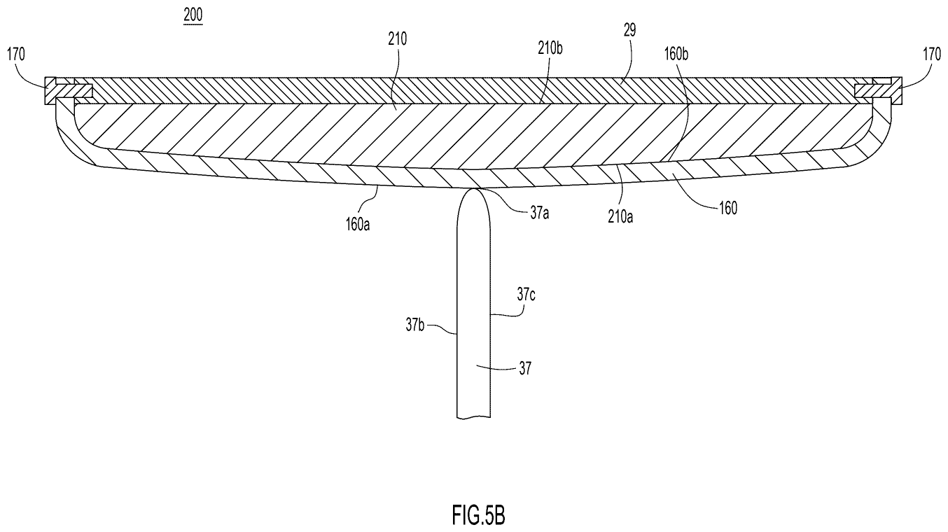

FIG. 5A is a cross-sectional view of a sector plate assembly 201 according to another implementation. The sector plate assembly 201 is substantially the same as the sector plate assembly 201 shown in FIG. 4A and includes the first elastomeric member 160 that is attached to the sector plate 29. The sector plate assembly 201 of FIG. 5A differs from that of FIG. 4A in that the sector plate assembly 201 includes a second elastomeric member 210 located in the gap (i.e., the gap 180 of the sector plate assembly 162) between the inner surface 160b of the first elastomeric member 160 and the first surface 29a of the sector plate 29. For example, a first surface 210a (e.g., a bottom surface) of the second elastomeric member 210 may be in contact with the inner surface 160b of the first elastomeric member 160, and a second surface 210b (e.g., a top surface) of the second elastomeric member 210 may be in contact with the first surface 29a of the sector plate 29. This feature provides redundancy in that, upon an inadvertent failing of the first elastomeric member 160 (e.g. it being broken/severed), the second elastomeric member 210 may be acted on by a radial plate to maintain a seal between the adjacent zones of the RAM, or to at least minimize fluid flow leakage between the adjacent zones.

In different embodiments, the elastomeric member 210 may be secured to the sector plate 29 in any desirable manner, either alone or in combination with the first elastomeric member 160. Moreover, while not shown, in some instances the second elastomeric member 210 may fully capture the sector plate 29, e.g., by wrapping around lateral sides of the sector plate 29, with the lateral sides bounding a direction that extends perpendicularly to a direction spanning side ends shown in FIG. 5A. In other instances, however, the lateral sides of the sector 29 need not be captured and/or need not be fully covered by elastomeric member 210 if desired.

FIG. 5B illustrates a sealing arrangement 200 wherein the sector plate assembly 201 of FIG. 5A is acted upon by an end surface 37a of a radial plate 37 to form a seal between, for example, zones Z1 and Z3 of a RAM. If the first elastomeric member 160 fails, this failure may expose the first surface 210a of the second elastomeric member 210 to the radial plate 37. Consequently, the end surface 37a of the radial plate 37 may contact the first surface 210a.

The second elastomeric member 210 may additionally function to support the first elastomeric member 160 and can be configured in a variety of ways to affect the amount by which the first elastomeric member 160 flexes when the second surfaces 37a of the radial plates 37 press against the outer surface 160a of the first elastomeric member 160. The second elastomeric member 210 also provides support to the first elastomeric member 160 to withstand the cyclic loading of the radial plate 37. By way of example, the second elastomeric member 210 may impart a force that urges the first elastomeric member 160 toward the radial plate 37, and/or the second elastomeric member 210 may resist a force urging the first elastomeric member 160 toward the sector plate 29. According to some implementations, the second elastomeric member 210 is softer than the first elastomeric member 160 (i.e., has a lower Young's modulus than the first elastomeric member 160).

In the examples of FIGS. 5A-B, the second elastomeric member 210 occupies all or substantially all of the gap/cavity that exists between the inner surface 160b of the first elastomeric member 160 and the first surface 29a of the sector plate 29. According to other implementations, as shown in FIG. 6 illustrating a cross-sectional view of a sector plate assembly 302, a second elastomeric member 310 may occupy less than all of the cavity/gap between the inner surface 160b of the first elastomeric member 160 and the first surface 29a of the sector plate 29. According to one such implementation, as shown in FIG. 6, a first surface 310a (e.g., a bottom surface) of the second elastomeric member 310 abuts the inner surface 160b of the first elastomeric member 160, and a second surface 310b (e.g., a top surface) of the second elastomeric member 310 faces the first surface 29a of the sector plate 29 with a gap/cavity 181 existing between the second surface 310b and the first surface 29a.

According to some implementations, the second elastomeric members 210 and 310 are each a unitary structure that is made from a single piece of material such that a single, integral component is positioned in the gap between the inner surface 160b of the first elastomeric member 160 and the first surface 29a of sector plate 29. However, according to other implementations, multiple, separate components are positioned in the gap between the inner surface 160b of the first elastomeric member 160 and the first surface 29a of the sector plate 29.

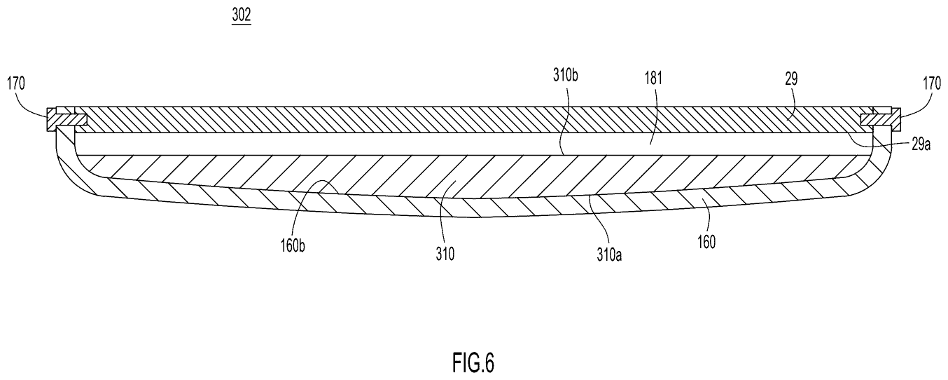

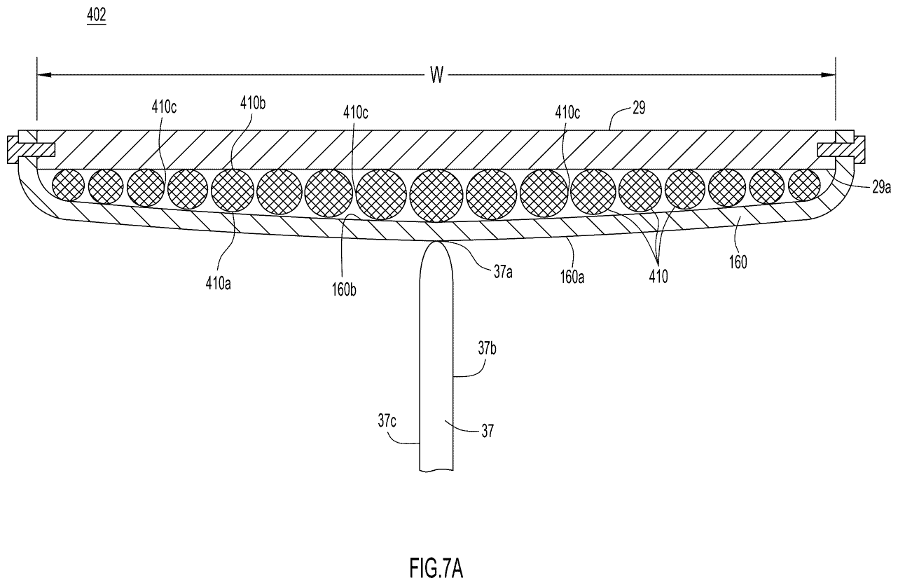

FIG. 7A illustrates a cross-sectional view of a sector plate assembly 402 with a plurality of elongate elastomeric members 410 that are arranged side-by-side in the gap between the inner surface 160b of the first elastomeric member 160 and the first surface 29a of sector plate 29, such as secured to the first elastomeric member 160 and/or to the sector plate 29. In different embodiments, one or more of the elastomeric members 410 may be secured to the sector plate 29 in any desirable manner, either alone or in combination with each other and/or the first elastomeric member 160. Moreover, while not shown, in some instances the second elastomeric member 210 may fully capture a lateral dimension of the sector plate 29, e.g., by wrapping around lateral sides of the sector plate 29, with the lateral sides bounding a direction that extends perpendicularly to a direction spanning side ends shown in FIG. 7A. In other instances, however, the lateral sides of the sector 29 need not be captured and/or need not be fully covered by elastomeric members 410 if desired.

According to some implementations, one or more or all of the elongate elastomeric members 410 is in the form of a solid cylinder as shown in FIG. 7B or in the form of a hollow cylinder as shown in FIG. 7C. According to other implementations, one or more of the elongate elastomeric members are in the form of other shapes, such as, for example, a rectangular prism, a triangular prism, an ellipsoidal prism, etc.

As shown in FIG. 7A, according to some implementations, the diameters of the elongate elastomeric members 410 may vary along a width “W” of the sector plate 29. In the example of FIG. 7A, each elongate elastomeric member 410 has a first surface 410a that continuously contacts the inner surface 160b of the first elastomeric member 160, as well as a second surface 410b that continuously contacts the first surface 29a of the sector plate 29. According to some implementations, elongate elastomeric members 410 are configured and arranged such that side surfaces 410c of adjacent elongate elastomeric members 410 abut one another and, in some implementations, are fixed to one another. Such arrangements impede fluid flow leakage across the sector plate 29 in the event that the first elastomeric member 160 is breached due to having been damaged (e.g., torn, cracked, worn through, etc.). In certain embodiments, if the first elastomeric member 160 fails, this failure exposes at least one of the elongate elastomeric members 410, which remain secured to the sector plate 29, to the radial plate 37, and the second surface 37a of the radial plate 37 may contact one of the elongate elastomeric members 410 (e.g., a first surface 410a of one of the elongate elastomeric members 410). According to some implementations, one or more or all of the elongate elastomeric members 410 is/are made of a material that is softer than the material of which the first elastomeric member 160 is made (i.e. has a lower Young's modulus than the material from which the first elastomeric member is made).

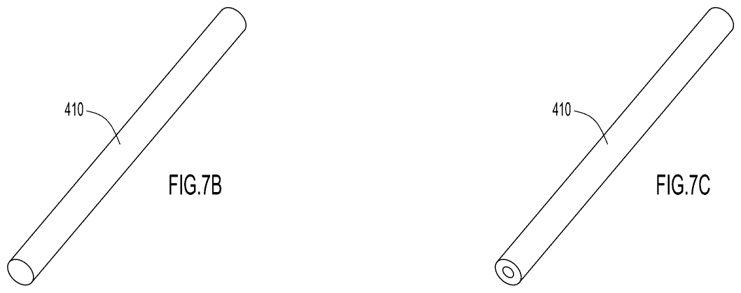

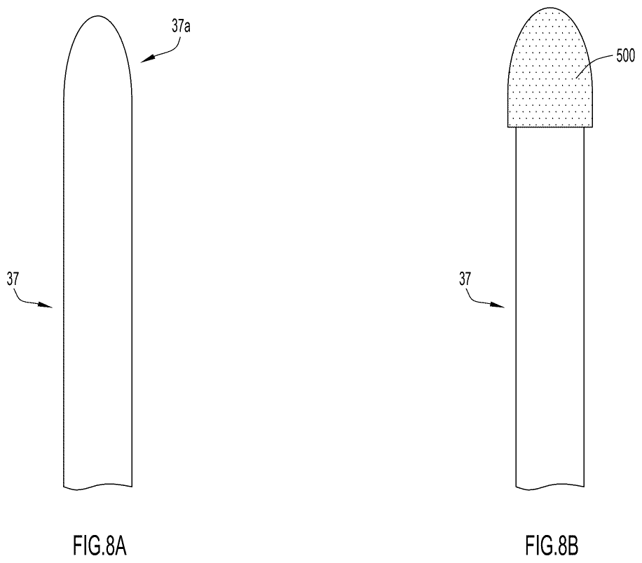

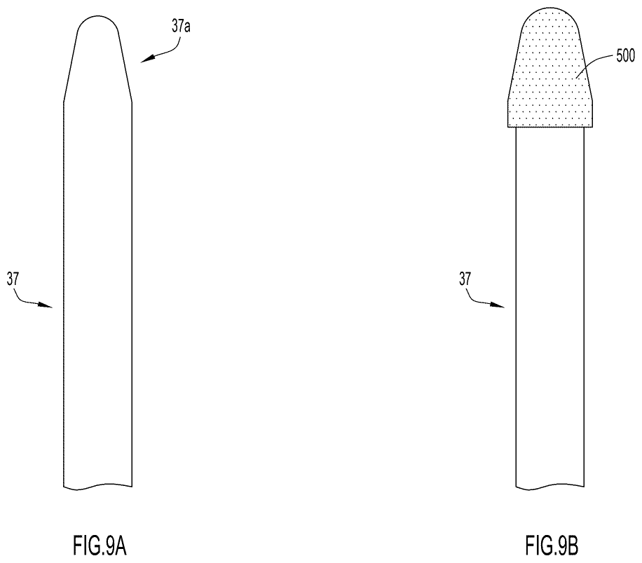

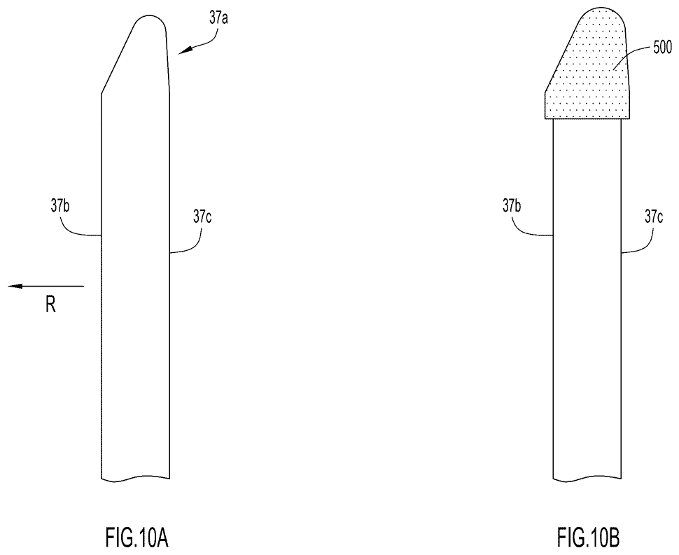

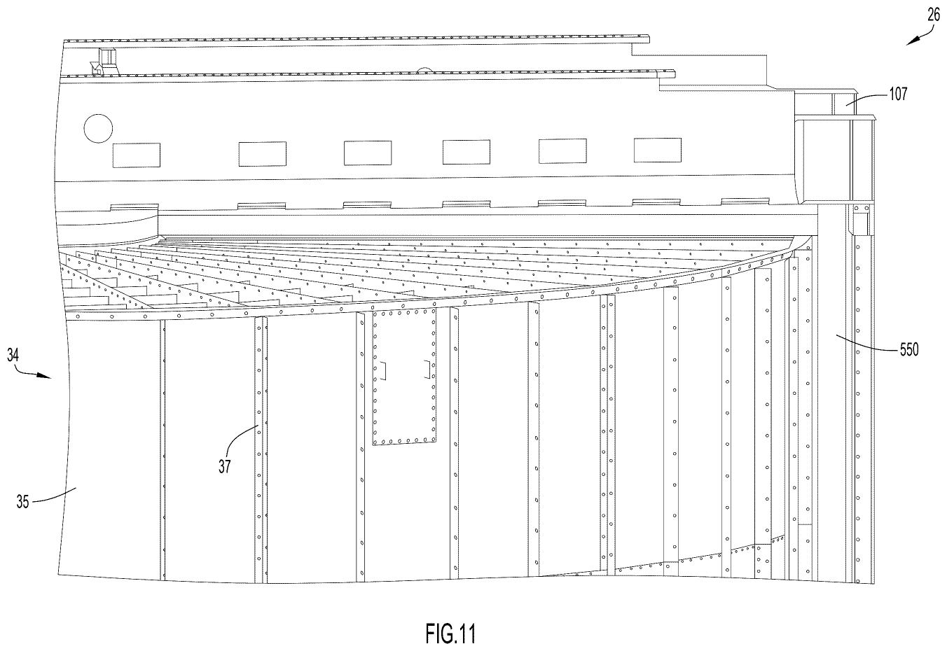

In the implementations of FIGS. 8A and 8B, an end of the radial plate 37 is rounded or otherwise curved. Such a profile of the radial plate 37 can reduce the risk of the radial plates 37 puncturing an elastomeric member being punctured by the radial plates 37 as the radial plates 37 pass along the elastomeric member. That is, curved radial plates 37 avoid imparting an excessive amount of force against an elastomeric member, which reduces the chance of the radial plate 37 penetrating the elastomeric member, further extending the useful life of the elastomeric member. In the implementations of FIGS. 9A and 9B, an end of the radial plate 37 includes opposing ascending and descending chamfered portions 38a and 38b, respectively located on the first and second sides 37b and 37c of the radial plate 37, which can further help avoid puncturing an elastomeric member. However, as shown in FIGS. 10A and 10B, according to some implementations, only the second side 37b (e.g., a leading side that first contacts an elastomeric member during rotation of the rotor) of the radial plate 37 includes a chamfered portion. In these embodiments, the chamfered portions may facilitate an unimpeded transition over the elastomeric member to allow the radial plate 37 to traverse the elastomeric member with less resistance.

To reduce friction forces between the contacting surfaces of the radial plates and the first elastomeric member 160, the second surfaces 37a of the radial plates 37 may comprise a lubricious coating 500, as shown in FIGS. 8B, 9B, and 10B. The use of the lubricious coating 500 facilitates movement of the radial plates 37 along an elastomeric member, thereby reducing wear on the outer surface of the elastomeric member (e.g., wear otherwise caused by abrasion of the radial plates 37 against the elastomeric member), and thus contributes to extending the useful life of the elastomeric member. The lubricious coating may comprise, for example, polytetrafluoroethylene (PTFE).

As noted above, according to some implementations, separate radial seal elements/fixtures attached to the top and bottom of the radial plates 37 can be included. These seal elements/fixtures can be chamfered, lubricated, and/or constructed from an alternative material to ease sliding across the elastomeric member and minimize wear. In the context of the present application, reference made herein to the radial plate 37 making contact with an elastomeric member (e.g., the first elastomeric member 160) is inclusive of any element/fixture attached to the radial plate 37 making contact with the elastomeric member.

The sealing techniques disclosed herein can also be implemented in other sealing plates of a RAM to provide desirable sealing against a rotor (e.g., between zones). The examples disclosed below are directed to sealing arrangements between an axial plate/segment and radial plates/segments. FIG. 11 illustrates the RAM 26 in greater detail by illustrating a detailed view of a portion of the RAM 26. The housing 107 includes an axial plate/segment 550 positioned radially outward of the rotor 34, such as beyond a circumference of the rotor 34, between top and bottom sector plates, and/or extending along the outer shell 35 (e.g., a circumference of the outer shell 35) of the rotor 34. It is desirable to provide a seal between the axial plate 550 and the rotor 34 to block fluid flow (e.g., circumferential fluid flow) between the axial plate 550 and the rotor 34 to minimize or eliminate fluid flow between zones (e.g., zones Z1 and Z3) of the RAM 26, for example.

To allow rotation of the rotor 34 within its housing, there is often a gap between a surface (e.g., an inner surface) of the axial plate 550 and a surface (e.g., an outer surface) of the rotor 34. To partially close this gap, the radial plates 37 of the rotor 34 may extend radially beyond the outer shell 35 of the rotor 34 and/or the outer shell 35 may include radially extending flanges, which may be aligned with radial plates 37. Either way, a gap may still be formed between the axial plate 550 and the radial plates 37, as well as between the axial plate 550 and the outer shell 35, as the rotor 34 rotates. For this reason, an elastomeric member is coupled to the axial plate 550 to effectuate a seal against the rotor 34 and block fluid flow between the axial plate 550 and the rotor 34.

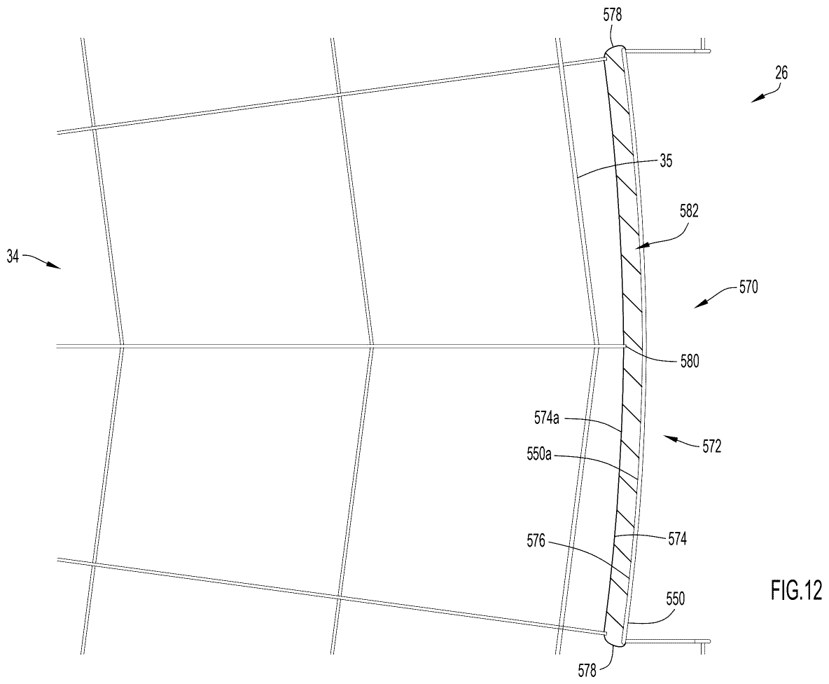

FIG. 12 is a top view of the RAM 26 providing additional details regarding a sealing arrangement 570 to block fluid flow between the axial plate 550 and the rotor 34. In particular, an axial plate assembly 572 includes an elastomeric member 574 attached to the axial plate 550 and extends from an inner surface 576 of the elastomeric member 574 towards the rotor 34. Rotation of the rotor 34, e.g., intermittent and sequential rotation, moves the radial plates 37 to touch or press against an outer surface 574a of the elastomeric member 574 to form a seal that prevents, or at least minimizes, fluid flow between the axial plate 550 and the rotor 34.

The axial plate assembly 572 may have features similar to that of any of the sector plate assemblies 162, 201, 302, 402 discussed above. As an example, the elastomeric member 574 may have a U-shaped configuration with side ends 578 attached to the axial plate 550 (e.g., via screws) to capture the axial plate 550 between the side ends 578. As another example, the elastomeric member 574 may be curved to form a convex shape with an apex 580 configured to be in contact with the radial plates 37. As a further example, there may be a gap 582 formed between the elastomeric member 574 and a surface 550a of the axial plate 550, and one or more additional elastomeric members (e.g., a unitary elastomeric member, elongate elastomeric members) are disposed in the gap 582 to provide continued sealing advantages upon failing of the elastomeric member 574.

Additionally, although the illustrated elastomeric member 574 extends across all of the surface 550a (e.g., an entire width of the axial plate 550), according to other implementations, the elastomeric member 574 may extend over only a portion (e.g., a central portion) of the surface 550a. Likewise, the elastomeric member 574 may extend over any portion of a height of the axial plate 550. Moreover, in additional or alternative implementations, the elastomeric member 574 is configured to contact and seal against the outer shell 35 of the rotor 34. In any case, the axial plate assembly 572 is arranged to block fluid flow along a circumference of the rotor 34 between the rotor 34 and the axial plate 550.

Overall, the RAM implementations provided herein achieve at least the advantages described herein. However, to be clear, while the application utilizes specific implementations to describe the RAM, as well as the advantages thereof, it is not intended to be limited to the details shown. Instead, it will be apparent that various modifications and structural changes may be made therein without departing from the scope of the inventions and within the scope and range of equivalents of the claims. In addition, various features from one of the implementations may be incorporated into another of the implementations.

It is also to be understood that the sector plates described herein, or portions thereof may be fabricated from any suitable material or combination of materials, such as metals or synthetic materials including, but not limited to, plastic, rubber, derivatives thereof, and combinations thereof. It is also intended that the present invention cover the modifications and variations of this invention that come within the scope of the appended claims and their equivalents. For example, it is to be understood that terms such as “top”, “bottom”, “front”, “side”, “length”, “width” and the like as may be used herein, merely describe points of reference and do not limit the present invention to any particular orientation or configuration.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

1. A rotary machine, comprising:
a rotor comprising a plurality of plates defining openings therebetween, wherein the rotor is configured to rotate to move the plurality of plates;
a housing enclosing the rotor; and
an elastomeric member attached to a surface of the housing, wherein the elastomeric member extends from the surface of the housing toward the rotor and is curved to form a convex shape with an apex configured to intermittently and sequentially engage with the plurality of plates to form a seal with the rotor during rotation of the rotor.

2. The rotary machine of claim 1, wherein the rotary machine comprises a plurality of zones, each zone of the plurality of zones is configured to receive a different fluid flow, the housing comprises a sector plate extending along a surface of the rotor between adjacent zones of the plurality of zones, and the surface of the housing to which the elastomeric member is attached is of the sector plate.

3. The rotary machine of claim 1, wherein the housing comprises an axial plate extending along a circumference of an outer shell of the rotor, and the surface of the housing to which the elastomeric member is attached is of the axial plate.

4. The rotary machine of claim 1, wherein each plate of the plurality of plates comprises an end surface configured to engage with the elastomeric member, and the end surface is curved, is chamfered, comprises a lubricious coating, or any combination thereof.

5. The rotary machine of claim 1, wherein the elastomeric member comprises a U-shaped configuration capturing a segment of the housing to attach to the surface of the housing.

6. The rotary machine of claim 1, comprising adsorbent material disposed in the openings defined between the plurality of plates.

7. The rotary machine of claim 1, wherein the rotary machine comprises a rotary heat exchanger.

8. A sealing arrangement for a rotary machine, the sealing arrangement comprising:
a housing segment extending along a rotor of the rotary machine, the rotor comprising a plurality of radial plates, and the rotor being configured to rotate the plurality of radial plates; and
an elastomeric member comprising side ends configured to attach to opposite walls of the housing segment to capture the housing segment between the side ends, wherein the elastomeric member extends from the housing segment toward the rotor to intermittently and sequentially engage with the plurality of radial plates of the rotor as the rotor rotates the plurality of radial plates.

9. The sealing arrangement of claim 8, wherein the elastomeric member comprises a U-shaped configuration defining an apex configured to intermittently and sequentially engage with the plurality of radial plates of the rotor as the rotor rotates the plurality of radial plates.

10. The sealing arrangement of claim 8, comprising a fastener extending through a side end to couple the side end to the housing segment.

11. The sealing arrangement of claim 8, wherein the elastomeric member extends from the housing segment toward the rotor to form a gap between the elastomeric member and the housing segment.

12. The sealing arrangement of claim 11, comprising an additional elastomeric member disposed in the gap.

13. The sealing arrangement of claim 12, wherein the additional elastomeric member is softer than the elastomeric member.

14. The sealing arrangement of claim 12, wherein the additional elastomeric member is in contact with the elastomeric member and the housing segment.

15. The sealing arrangement of claim 11, comprising a plurality of additional elastomeric members disposed in the gap and arranged side by side along the housing segment within the gap.

16. A rotary machine, comprising:
a rotor comprising a plurality of radial plates, wherein the rotor is configured to rotate to move the plurality of radial plates;
a housing enclosing the rotor, wherein the housing comprises a segment extending along the rotor; and
an elastomeric member attached to the plate of the housing, wherein the elastomeric member extends from the segment to sealingly engage with the rotor and form a gap between the elastomeric member and the segment.

17. The rotary machine of claim 16, wherein the rotor is configured to receive a fluid flow directed from a first side of the rotor to a second side, opposite the first side, of the rotor, and the plate of the housing extends along one of the first side or the second side.

18. The rotary machine of claim 16, wherein the plate of the rotor is positioned radially outward of the rotor.

19. The rotary machine of claim 16, wherein the elastomeric member comprises a U-shaped configuration with side ends attached to the plate of the housing.

20. The rotary machine of claim 19, wherein the elastomeric member comprises a curved portion between the side ends, and the elastomeric member forms a gap between the curved portion and the plate.
